(19) United States
(12) Patent Application Publication
(10) Pub. No.: US 2023/0205212 A1
(43) Pub. Date: Jun. 29, 2023

(54) MAPPING METHOD FOR MOBILE ROBOT, MOBILE ROBOT AND COMPUTER-READABLE STORAGE MEDIUM

(71) Applicant: UBTECH ROBOTICS CORP LTD, Shenzhen (CN)

(72) Inventors: Wanjun He, Shenzhen (CN); Zhichao Liu, Shenzhen (CN); Youjun Xiong, Shenzhen (CN)

(21) Appl. No.: 18/171,630

(22) Filed: Feb. 20, 2023

Related U.S. Application Data
(63) Continuation of application No. PCT/CN2020/140420, filed on Dec. 28, 2020.

(30) Foreign Application Priority Data
Aug. 20, 2020 (CN) 202010843669.2

(51) Int. Cl. G05D 1/02

(52) U.S. Cl. CPC G05D 1/0212; G05D 1/0274

(57) ABSTRACT

A mapping method for a mobile robot includes: obtaining positions of particles corresponding to the mobile robot using a particle filtering approach; selecting one of the particles with a largest weight in a particle swarm corresponding to a current time point, performing position matching between the one of the particles and a historical trajectory formed by the one of the particles with the largest weight, and determining whether the positions of the particles corresponding to the mobile robot match positions of historical trajectory points of the mobile robot; in response to the positions of the particles corresponding to the mobile robot matching the positions of the historical trajectory points of the mobile robot, optimizing a trajectory of the mobile robot using a graph optimization approach; and building a map based on the optimized trajectory.

### CROSS REFERENCE TO RELATED APPLICATIONS

The present application is a continuation-application of International Application PCT/CN2020/140420, with an international filing date of Dec. 28, 2020, which claims foreign priority to Chinese Patent Application No. 202010843669.2, filed on Aug. 20, 2020 in the China National Intellectual Property Administration, the contents of all of which are hereby incorporated by reference in its entirety.

### TECHNICAL FIELD

The present disclosure generally relates to mobile robots, and particularly to a mapping method for a mobile robot and a mobile robot.

### BACKGROUND

Mobile robots have been used in several different application areas. During the automatic execution of tasks by mobile robots, it is usually necessary to obtain scene map information. According to the acquired scene map information, the robots can automatically complete the required tasks.

When building a map of the scene where a mobile robot is located, the particle filtering approach or graph optimization approach is usually used to locate the robot. However, in large-scale scenes, due to the particle group not being able to be match and converge to the correct position, or the measurement error generated when the single path adopted by the graph optimization approach is updated, it may lead to a large deviation of the trajectory of the robot, which is not conducive to reducing the error of the map constructed by the robot.

Therefore, there is a need to provide a mapping method to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a mobile robot according to one embodiment.

FIG. 2 is an exemplary flowchart of a mapping method according to one embodiment.

FIG. 3 is an exemplary flowchart of a mapping method according to another embodiment.

FIG. 4 is a schematic graph network diagram.

FIG. 5 is schematic block diagram of a mapping device for a mobile robot according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

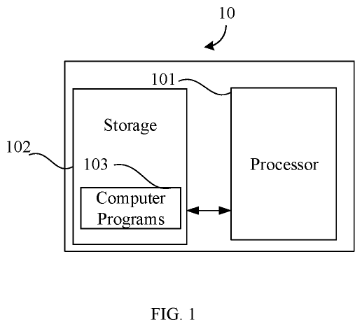

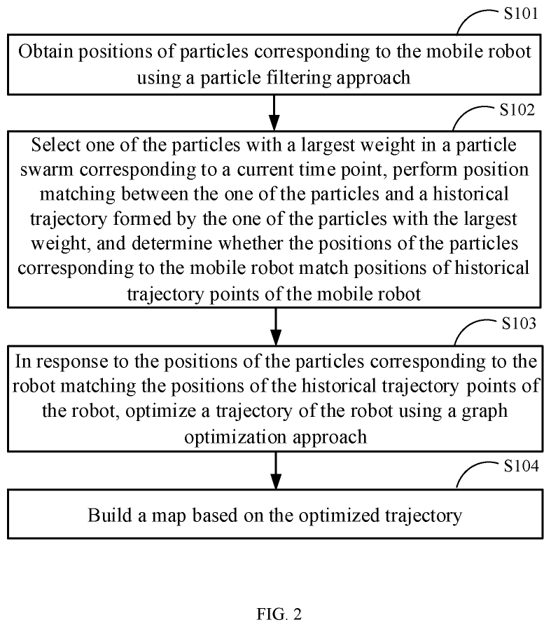

FIG. 1 shows a schematic block diagram of a mobile robot 10 (e.g., autonomous robot) according to one embodiment. The robot 10 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of the method for controlling the robot, such as steps S101 to S104 in FIG. 2, are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot, such as a hard disk or a memory. The storage 102 may also be an external storage device of the robot, such as a plug-in hard disk, a smart memory card (SMC), and a secure digital (SD) card, or any suitable flash cards. Furthermore, the storage 102 may also include both an internal storage unit and an external storage device. The storage 102 is used to store computer programs, other programs, and data required by the robot. The storage 102 can also be used to temporarily store data that have been output or is about to be output.

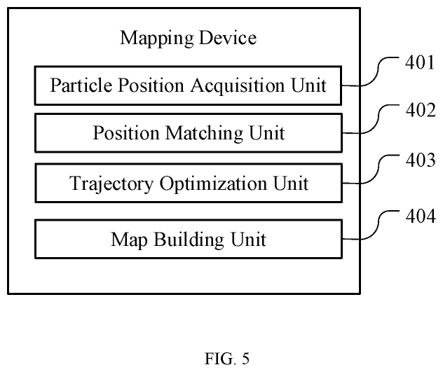

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot. For example, the one or more computer programs 103 may be divided into a particle position acquisition unit 401, a position matching unit 402, a trajectory optimization unit 403, and a map building unit 404 as shown in FIG. 5.

It should be noted that the block diagram shown in FIG. 1 is only an example of the robot. The robot may include more or fewer components than what is shown in FIG. 1, or have a different configuration than what is shown in FIG. 1. Each component shown in FIG. 1 may be implemented in hardware, software, or a combination thereof

In one embodiment, a mapping method for the mobile robot 10 may include the following steps.

Step S101: Obtain positions of particles corresponding to the mobile robot using a particle filtering approach.

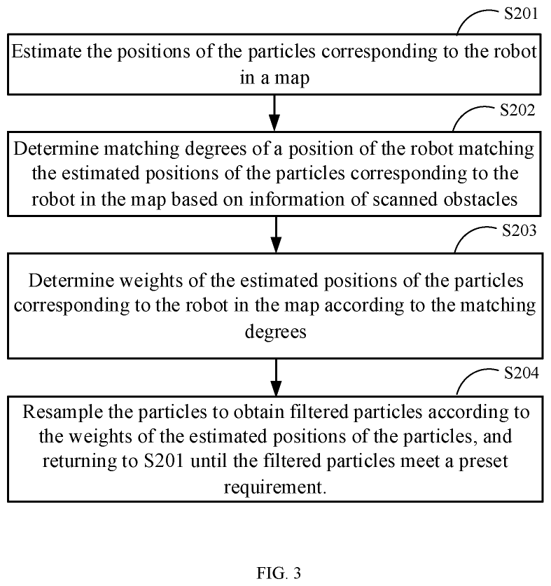

Particle filtering uses a set of particles (also called samples) to represent to represent probabilities, and its distribution is represented by random state particles extracted from posterior probability. After receiving the laser data, the robot performs pose matching on each frame of the scanned laser data, and performs motion estimation on the pose of the robot. After motion estimation and scan matching, the weights of the particles are updated, and the particles with updated weights are resampled to ensure the diversity of particles. Referring to FIG. 3, in one embodiment, step S101 may include the following steps.

Step S201: Estimate the positions of the particles corresponding to the robot in a map.

According to the odometry data output by wheel encoders, the robot can estimate the pose of the robot through an odometer motion model, and obtain the positions of multiple particles corresponding to the robot. The positions of the particles are to represent the position of the robot. In the process of particle filtering, the positions of the particles are also the particles in the map.

In one embodiment, other sensors of the robot may also be used to estimate the positions of the particles corresponding to the robot on the map. For example, speed sensors and orientation sensors can be used to detect the moving distance and direction of the robot. The position of the robot at the current moment can be estimated based on the moving speed and moving direction, and the positions of the particles corresponding to the position of the robot can be determined.

The positions of the particles of the robot estimated at the current moment can be estimated based on the positions of the particles corresponding to the robot at the previous moment before the current moment. There may be multiple positions of particles corresponding to the robot at the previous moment, and multiple positions of particles corresponding to the robot at the current moment may be estimated based on the multiple positions of the particles at the previous moment. The positions of the particles at the previous moment may be a particle swarm optimized by the particle filter approach, that is, the positions of the particles at the previous moment may include one or more. Alternatively, the positions of particles at the previous moment may also be the positions determined by the robot through the collected information of obstacles.

Step S202: Determine matching degrees of a position of the robot matching the estimated positions of the particles corresponding to the robot in the map based on information of scanned obstacles.

At the current moment, after obtaining the estimated positions of the particles of the robot through motion sensing devices or other sensing devices, the information of obstacles collected at the current moment can be obtained.

According to the positions of the particles of the robot estimated in step S201 at the current moment, combined with the information of obstacles scanned by the robot before the current moment, information of obstacles corresponding to the estimated positions of particles can be obtained respectively. The information of obstacles may include the distances between the positions of particles and the obstacles, and the orientation relationship between the positions of particles and the obstacles.

The estimated information of obstacles corresponding to each position of particle at the current moment may be compared with the currently collected information of obstacles, including the comparison of the estimated information of obstacles with each of the above-mentioned distances, and the comparison of the estimated information of obstacles with each of the above-mentioned orientation relationship. The matching degrees of the positions of particles and the position of the robot can be determined according to the matching degrees in relation to the above-mentioned distances and orientation information.

In one embodiment, matching can be performed between the scanned obstacles and the obstacles corresponding to the positions of particles. Then, find the obstacles corresponding to the positions of particles closest to the scanned obstacles, and the distances between the scanned obstacles and the obstacles corresponding to the closest positions of particles can be obtained. For example, when N (N is greater than or equal to 1) obstacles are scanned, among the obstacles corresponding to the positions of particles to be matched and calculated, N obstacles closet to the N obstacles can be found, and the distance between each scanned obstacle and its closest obstacle is calculated. The poses of the scanned obstacles in the map (which can be a grid map) are represented by Pmapi, the estimated positions of particles correspond to the poses of the obstacles are represented by Phiti, and the distances between each scanned obstacle and its closest obstacle is represented by dis(Pmapi,Phiti). In one embodiment, the matching degree between the positions of particles and the information of obstacles scanned by the laser frame can be expressed as follows:

$$score = {\sum }_{i = 1}^{N} ln ( d i s ( {p}_{mapi} , {p}_{hiti} ) ) .$$

Step S203: Determine weights of the estimated positions of the particles corresponding to the robot in the map according to the matching degrees.

In one embodiment, after the matching degrees between the robot and the particles are calculated, the matching degrees can be used as the weights of the robot corresponding to the positions of the particles, that is, the weights of the positions of the particles.

In one embodiment, the weight w of each of the positions of the particles at the current moment can be expressed as the sum of its weights added up at all moments. That is, by calculating the weights w1, w2 . . . wi of the positions of a certain particle at each moment, the weight of the positions of the particle at the i-th moment can be expressed as: w1+w2+ . . . +wi.

In one embodiment, in order to weigh the weights of the particles at each moment, after obtaining the weights w of the positions of the particles, they can be normalized. The normalized weight w̅ of one particle represents the weight of the current position of the particle divided by the sum of the weights of all of the positions of the particle, which can be expressed as follows:

$$w = {\sum }_{t = 0}^{T} {score}_{t} , \overline{w} = \frac{w}{{\sum }_{i = 0}^{M} {w}_{i}} ,$$

where scoreₜ represents the matching degree of a particle at a certain moment, wᵢ represents the weight of the particle, and M represents the total number of the particles.

Step S204: Resample the particles to obtain filtered particles according to the weights of the estimated positions of the particles, and returning to S201 until the filtered particles meet a preset requirement.

After the weight corresponding to each particle position at the current moment is obtained, particle resampling can be performed according to the weights. In the resampling process, the particle position with a larger weight has a higher probability of being selected by sampling, and the particle position with a smaller weight has a lower probability of being selected by sampling.

The similarity of the weights of the particles, which indicates whether the distribution of particles is uniform, can be determined by pre-set indicators. For example, a monitoring index Neff can be used to evaluate the similarity of particles, which can be expressed as follows:

$$Neff = \frac{1}{{\sum }_{i = 0}^{M} {( {\overline{w}}_{i} )}^{2}} ,$$

w̅ᵢ represents the normalized weight of the i-th particle, and M represents the total number of the particles.

When the monitoring index is lower than a preset threshold, it indicates that the distribution of particles is uneven, some particles are closer to the true values, and some particles are farther from the true values, and resampling is required. Resampling removes the positions of particles with smaller weights, and performs multiple sampling around the positions of particles with greater weights to form a new set of particles until the monitoring index is greater than or equal to the preset threshold, which indicates that the particles are evenly distributed near the true values.

Step S102: Select one of the particles with a largest weight in a particle swarm corresponding to a current time point, perform position matching between the one of the particles and a historical trajectory formed by the one of the particles with the largest weight, and determine whether the positions of the particles corresponding to the mobile robot match positions of historical trajectory points of the mobile robot.

In one embodiment, when determining whether the positions of the particles corresponding to the robot match positions of historical trajectory points of the robot, one of the particles with a largest weight in a particle swarm corresponding to a current time point can be selected first. Then, position matching can be formed between the one of the particles and historical trajectories formed by laser matching. In one embodiment, the position matching can be formed between the one of the particles with the largest weight and the history trajectory formed by the one of the particles with the largest weight. If the difference in position and pose between the particles at the current time and the particles in the historical trajectory is less than a preset threshold, it can be determined that the current positions of the particles and these historical trajectory points may form a loop.

In one embodiment, if the matching degree in position and pose between the particles at the current time and the particles in the historical trajectory is less than a preset threshold, and the particles of the matched history trajectories are not connected with the particles at the current time, it can be determined that the current positions of the particles and the historical trajectory form a loop, and the current positions of the particles are the loop points. This can avoid being mistaken for generating a loop when the robot is not moving.

Step S103: In response to the positions of the particles corresponding to the robot matching the positions of the historical trajectory points of the robot, optimize a trajectory of the robot using a graph optimization approach.

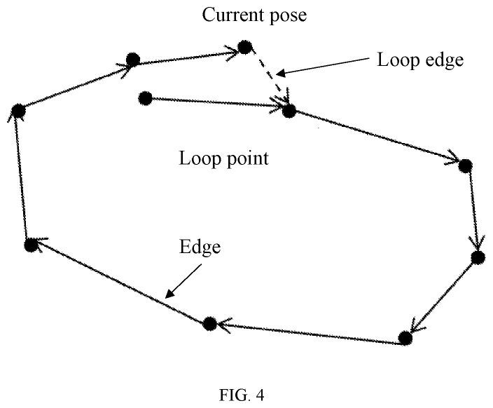

When the difference between the robot's position and pose at the current time and that of the particles in the historical trajectory is less than a preset difference threshold, or it is determined that the particles in the matching historical trajectory are not connected with the particles at the current time, it is determined that the current positions of the particles are the loop points. Referring to FIG. 4, the particle position at each moment in the loop is the loop node. The pose constraint relationship between nodes is represented by edge connection. The edge connecting the particles at the current time and the loop point can be called loop edge. A graph network is formed by nodes and edges.

Referring to FIG. 4, node poses are represented by T1, T2 . . . Tn, and the relative pose of the edge between node i and node j is represented by Tij, and an optimization error function can be expressed as follows: eᵢⱼ=ln(Tᵢⱼ⁻¹Tᵢ⁻¹Tⱼ)\check{ }. LM (Levenberg Marquardt) method can be used for optimization, and the trajectory can be adjusted to obtain the position and pose of each trajectory point with the minimum overall error.

The particles after graph optimization and correction have higher accuracy. On the basis of the corrected particles, the particles with smaller weights can be deleted by forced resampling. Based on the poses of particles with a higher weight, sampling forms a new particle set, and sets the weight of all sampled particles to 1/M (a total of M particles are sampled) to further calculate the matching degrees until the filtered particles meet a preset requirement.

Step S104: Build a map based on the optimized trajectory.

After the positions of the particles of the robot are processed by particle filtering and graph optimization, a more accurate historical trajectory can be obtained. Particles with higher weights can be selected to traverse the laser data corresponding to the entire historical trajectory. The laser data is stitched together to obtain a two-dimensional laser image, such as a two-dimensional laser grid map.

It should be understood that sequence numbers of the foregoing processes do not mean an execution sequence in this embodiment of this disclosure. The execution sequence of the processes should be determined according to functions and internal logic of the processes, and should not be construed as any limitation on the implementation processes of this embodiment of this disclosure.

Referring to FIG. 5, in one embodiment, a mapping device for a mobile robot may include a particle position acquisition unit 401, a position matching unit 402, a trajectory optimization unit 403, and a map building unit 404. The particle position acquisition unit 401 is to obtain positions of particles corresponding to the mobile robot using a particle filtering approach. The position matching unit 402 is to select one of the particles with a largest weight in a particle swarm corresponding to a current time point, perform position matching between the one of the particles and a historical trajectory formed by the one of the particles with the largest weight, and determine whether the positions of the particles corresponding to the mobile robot match positions of historical trajectory points of the mobile robot. The trajectory optimization unit 403 is to, in response to the positions of the particles corresponding to the robot matching the positions of the historical trajectory points of the robot, optimize a trajectory of the robot using a graph optimization approach. The map building unit 404 is to build a map based on the optimized trajectory.

It should be noted that the basic principles and technical effects of the robot control device are the same as the aforementioned method. For a brief description, for parts not mentioned in this device embodiment, reference can be made to corresponding description in the method embodiments.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented mapping method for a mobile robot, comprising:
obtaining positions of particles corresponding to the mobile robot using a particle filtering approach;
selecting one of the particles with a largest weight in a particle swarm corresponding to a current time point, performing position matching between the one of the particles and a historical trajectory formed by the one of the particles with the largest weight, and determining whether the positions of the particles corresponding to the mobile robot match positions of historical trajectory points of the mobile robot;
in response to the positions of the particles corresponding to the mobile robot matching the positions of the historical trajectory points of the mobile robot, optimizing a trajectory of the mobile robot using a graph optimization approach; and
building a map based on the optimized trajectory.

2. The method of claim 1, wherein obtaining the positions of the particles corresponding to the mobile robot using a particle filtering approach comprises:
a) estimating the positions of the particles corresponding to the mobile robot in the map;
b) determining matching degrees of a position of the mobile robot matching the estimated positions of the particles corresponding to the mobile robot in the map based on information of scanned obstacles;
c) determining weights of the estimated positions of the particles corresponding to the mobile robot in the map according to the matching degrees; and
d) resampling the particles to obtain filtered particles according to the weights of the estimated positions of the particles, and returning to a) until the filtered particles meet a preset requirement.

3. The method of claim 2, wherein determining the matching degrees of the position of the mobile robot matching the estimated positions of the particles corresponding to the mobile robot in the map based on the information of scanned obstacles, comprises:
obtaining positions of the obstacles scanned by the mobile robot;
obtaining estimated positions of corresponding obstacles according to the estimated positions of the particles; and
based on distances between the positions of the obstacles and the estimated positions of the corresponding obstacles, determining the matching degrees of the position of the mobile robot matching the estimated positions of the particles corresponding to the mobile robot.

4. The method of claim 3, wherein based on distances between the positions of the obstacles and the estimated positions of the corresponding obstacles, determining the matching degrees of the position of the mobile robot matching the estimated positions of the particles corresponding to the mobile robot, comprises:
determining smallest distances between the estimated position of each of the obstacles corresponding to the positions of the particles and the positions of the obstacles scanned by the mobile robot; and
calculating the matching degrees of the position of the mobile robot matching the estimated positions of the particles corresponding to the mobile robot, based on the smallest distances.

5. The method of claim 2, wherein determining weights of the estimated positions of the particles corresponding to the mobile robot in the map according to the matching degrees, comprises:
according to a sum of the matching degrees between the position of the mobile robot and the positions of the particles at different moments, obtaining weights of the particles; and
normalizing the weights of the particles to obtain weights of the positions of the particles corresponding to normalized particles.

6. The method of claim 1, wherein determining whether the positions of the particles corresponding to the mobile robot match positions of historical trajectory points of the mobile robot, comprises:
obtaining current poses of the particles at the current time point;
obtaining historical trajectory points determined separately at multiple moments before the current time point; and
performing matching between the current poses and the historical trajectory points determined separately at multiple moments before the current time point.

7. The method of claim 6, wherein optimizing the trajectory of the mobile robot using a graph optimization approach comprises:
constructing a graph network based on the historical trajectory points, and determining node poses and edge poses in the graph network; and
determining an error optimization function according to the node poses and edge poses, and optimizing poses of the particles in the historical trajectory points using the error optimization function.

8. A mobile robot comprising:
one or more processors; and
a memory coupled to the one or more processors, the memory storing programs that, when executed by the one or more processors, cause performance of operations comprising:
obtaining positions of particles corresponding to the mobile robot using a particle filtering approach;
selecting one of the particles with a largest weight in a particle swarm corresponding to a current time point, performing position matching between the one of the particles and a historical trajectory formed by the one of the particles with the largest weight, and determining whether the positions of the particles corresponding to the mobile robot match positions of historical trajectory points of the mobile robot;
in response to the positions of the particles corresponding to the mobile robot matching the positions of the historical trajectory points of the mobile robot, optimizing a trajectory of the mobile robot using a graph optimization approach; and
building a map based on the optimized trajectory.

9. The mobile robot of claim 8, wherein obtaining the positions of the particles corresponding to the mobile robot using a particle filtering approach comprises:
a) estimating the positions of the particles corresponding to the mobile robot in the map;
b) determining matching degrees of a position of the mobile robot matching the estimated positions of the particles corresponding to the mobile robot in the map based on information of scanned obstacles;
c) determining weights of the estimated positions of the particles corresponding to the mobile robot in the map according to the matching degrees; and
d) resampling the particles to obtain filtered particles according to the weights of the estimated positions of the particles, and returning to a) until the filtered particles meet a preset requirement.

10. The mobile robot of claim 9, wherein determining the matching degrees of the position of the mobile robot matching the estimated positions of the particles corresponding to the mobile robot in the map based on the information of scanned obstacles, comprises:
obtaining positions of the obstacles scanned by the mobile robot;
obtaining estimated positions of corresponding obstacles according to the estimated positions of the particles; and
based on distances between the positions of the obstacles and the estimated positions of the corresponding obstacles, determining the matching degrees of the position of the mobile robot matching the estimated positions of the particles corresponding to the mobile robot.

11. The mobile robot of claim 10, wherein based on distances between the positions of the obstacles and the estimated positions of the corresponding obstacles, determining the matching degrees of the position of the mobile robot matching the estimated positions of the particles corresponding to the mobile robot, comprises:
determining smallest distances between the estimated position of each of the obstacles corresponding to the positions of the particles and the positions of the obstacles scanned by the mobile robot; and
calculating the matching degrees of the position of the mobile robot matching the estimated positions of the particles corresponding to the mobile robot, based on the smallest distances.

12. The mobile robot of claim 9, wherein determining weights of the estimated positions of the particles corresponding to the mobile robot in the map according to the matching degrees, comprises:
according to a sum of the matching degrees between the position of the mobile robot and the positions of the particles at different moments, obtaining weights of the particles; and
normalizing the weights of the particles to obtain weights of the positions of the particles corresponding to normalized particles.

13. The mobile robot of claim 8, wherein determining whether the positions of the particles corresponding to the mobile robot match positions of historical trajectory points of the mobile robot, comprises:
obtaining current poses of the particles at the current time point;
obtaining historical trajectory points determined separately at multiple moments before the current time point; and
performing matching between the current poses and the historical trajectory points determined separately at multiple moments before the current time point.

14. The mobile robot of claim 13, wherein optimizing the trajectory of the mobile robot using a graph optimization approach comprises:
constructing a graph network based on the historical trajectory points, and determining node poses and edge poses in the graph network; and
determining an error optimization function according to the node poses and edge poses, and optimizing poses of the particles in the historical trajectory points using the error optimization function.

15. A non-transitory computer-readable storage medium storing instructions that, when executed by at least one processor of a mobile robot, cause the at least one processor to perform a method, the method comprising:
obtaining positions of particles corresponding to the mobile robot using a particle filtering approach;
selecting one of the particles with a largest weight in a particle swarm corresponding to a current time point, performing position matching between the one of the particles and a historical trajectory formed by the one of the particles with the largest weight, and determining whether the positions of the particles corresponding to the mobile robot match positions of historical trajectory points of the mobile robot;
in response to the positions of the particles corresponding to the mobile robot matching the positions of the historical trajectory points of the mobile robot, optimizing a trajectory of the mobile robot using a graph optimization approach; and
building a map based on the optimized trajectory.

16. The non-transitory computer-readable storage medium of claim 15, wherein obtaining the positions of the particles corresponding to the mobile robot using a particle filtering approach comprises:
a) estimating the positions of the particles corresponding to the mobile robot in the map;
b) determining matching degrees of a position of the mobile robot matching the estimated positions of the particles corresponding to the mobile robot in the map based on information of scanned obstacles;
c) determining weights of the estimated positions of the particles corresponding to the mobile robot in the map according to the matching degrees; and
d) resampling the particles to obtain filtered particles according to the weights of the estimated positions of the particles, and returning to a) until the filtered particles meet a preset requirement.

17. The non-transitory computer-readable storage medium of claim 16, wherein determining the matching degrees of the position of the mobile robot matching the estimated positions of the particles corresponding to the mobile robot in the map based on the information of scanned obstacles, comprises:
obtaining positions of the obstacles scanned by the mobile robot;
obtaining estimated positions of corresponding obstacles according to the estimated positions of the particles; and
based on distances between the positions of the obstacles and the estimated positions of the corresponding obstacles, determining the matching degrees of the position of the mobile robot matching the estimated positions of the particles corresponding to the mobile robot.

18. The non-transitory computer-readable storage medium of claim 17, wherein based on distances between the positions of the obstacles and the estimated positions of the corresponding obstacles, determining the matching degrees of the position of the mobile robot matching the estimated positions of the particles corresponding to the mobile robot, comprises:
determining smallest distances between the estimated position of each of the obstacles corresponding to the positions of the particles and the positions of the obstacles scanned by the mobile robot; and
calculating the matching degrees of the position of the mobile robot matching the estimated positions of the particles corresponding to the mobile robot, based on the smallest distances.

19. The non-transitory computer-readable storage medium of claim 16, wherein determining weights of the estimated positions of the particles corresponding to the mobile robot in the map according to the matching degrees, comprises:
according to a sum of the matching degrees between the position of the mobile robot and the positions of the particles at different moments, obtaining weights of the particles; and
normalizing the weights of the particles to obtain weights of the positions of the particles corresponding to normalized particles.

20. The non-transitory computer-readable storage medium of claim 15, wherein determining whether the positions of the particles corresponding to the mobile robot match positions of historical trajectory points of the mobile robot, comprises:
obtaining current poses of the particles at the current time point;
obtaining historical trajectory points determined separately at multiple moments before the current time point; and
performing matching between the current poses and the historical trajectory points determined separately at multiple moments before the current time point.
